(19) United States
(12) Patent Application Publication
(10) Pub. No.: US 2017/0334509 A1
(43) Pub. Date: Nov. 23, 2017

(54) Manual brake structure

(71) Applicants: Jun-Rui YANG, Taichung City (TW); Gui-Ping LIAO, Taichung City (TW); Zhen-Jie LIAO, Taichung City (TW)

(72) Inventors: Jun-Rui YANG, Taichung City (TW); Gui-Ping LIAO, Taichung City (TW); Zhen-Jie LIAO, Taichung City (TW)

(21) Appl. No.: 15/427,071

(22) Filed: Feb. 8, 2017

(30) Foreign Application Priority Data
May 19, 2016 (TW) 105207309

(51) Int. Cl. B62L 3/08; B62L 3/02; B62L 1/00

(52) U.S. Cl. CPC B62L 3/08; B62L 1/005; B62L 3/02

(57) ABSTRACT

A manual brake structure is employed to stop a bicycle or motorcycle and contains: a casing, a body, a roller, a first brake line, a second brake line, and a third brake line. The casing includes a first cap and a second cap. The body is housed in the casing and includes a first accommodation portion and a second accommodation portion having two first apertures. The roller is housed in the first accommodation portion and includes a trench. The first brake line is bent in half, fitted into the trench, and connected with a first brake and a second brake of the bicycle or motorcycle. The second brake line includes a first stop block and couples with a first controller of the bicycle or motorcycle. The third brake line includes a second stop block and couples with a second controller of the bicycle or motorcycle.

### FIELD OF THE INVENTION

The present invention relates to a manual brake structure which is employed to stop a bicycle or motorcycle.

### BACKGROUND OF THE INVENTION

Referring to FIGS. 7 and 8, a conventional brake structure contains a first brake line 1, a connection device 2, and a second brake line 3. Two ends 11 of the first brake line 1 are in connection with two controllers of two handles respectively, and a middle section of the first brake line rolls around a roller 221 of the connection device 2. The connection device 2 includes a cap 212 and a cylinder 211, wherein the cylinder 211 has a slide block 22 housed therein, the slide block 22 has an opening defined thereon so as to accommodate the roller 221, and the second brake line 3 is fixed below the slide block 22. When the first brake line 1 is pulled, it drives the roller 221 to rotate and actuates the slide block 22 to slide in the cylinder 221, and the second brake line 2 is pulled as pulling the first brake line 1 simultaneously so as to control two brakes of two wheels.

However, when one of the two controllers is pressed, the first brake line cannot drive the slide block to move upwardly, and the roller rotates so as to actuate the slide block to move upwardly. Accordingly, the two wheels are stopped by pressing the two controllers simultaneously.

Furthermore, when the first brake line does not contact with the roller tightly, it is loose and contacts with the cylinder, thus stopping the two wheels poorly.

The present invention has arisen to mitigate and/or obviate the afore-described disadvantages.

### SUMMARY OF THE INVENTION

The primary objective of the present invention is to provide a manual brake structure which brakes two wheels of the bicycle or motorcycle simultaneously.

Further objective of the present invention is to provide a manual brake structure in which the roller drives the first brake and the second brake so as to stop the two wheels of the bicycle or motorcycle gently.

Another objective of the present invention is to provide a manual brake structure which a tightness of the first brake line is adjusted automatically by the roller so as to stop the two wheels quickly and stably, when the first brake line is loose.

To obtain the above objectives, a manual brake structure provided by the present invention is employed to stop a bicycle or motorcycle and contains: a casing, a body, a roller, a first brake line, a second brake line, and a third brake line.

The casing is a hollow cylinder and includes a first cap arranged on a first end of the casing, the casing also includes a second cap arranged on a second end of the casing, and each of the first cap and the second cap having two through orifices.

The body is housed in the casing and includes a first accommodation portion formed in a first end of the body so as to house a roller, and the body also includes a second accommodation portion formed in a second end of the body, the second accommodation portion has two first apertures defined on the second accommodation portion.

The roller includes a trench defined around a peripheral wall of the roller.

An intermediate section of the first brake line is bent in half and is fitted into the trench of the roller, and two ends of the first brake line are respectively connected with a first brake and a second brake of the bicycle or motorcycle.

The second brake line includes a first stop block secured on a first end of the second brake line, and a second end of the second brake line extends out of the first aperture of the second accommodation portion and couples with a first controller of the bicycle or motorcycle.

The third brake line includes a second stop block mounted on a first end of the third brake line, and a second end of the third brake line extends out of the first aperture of the second accommodation portion and couples with a second controller of the bicycle or motorcycle.

### BRIEF DESCRIPTION OF THE DRAWINGS

FIG. 1 is a perspective view showing the assembly of a manual brake structure according to a preferred embodiment of the present invention.

FIG. 2 is a perspective view showing the exploded components of the manual brake structure according to the preferred embodiment of the present invention.

FIG. 3 is a cross sectional view showing the assembly of the manual brake structure according to the preferred embodiment of the present invention.

FIG. 4 is a cross sectional view showing the operation of the manual brake structure according to the preferred embodiment of the present invention.

FIG. 5 is another cross sectional view showing the operation of the manual brake structure according to the preferred embodiment of the present invention.

FIG. 6 is a perspective view showing the application of the manual brake structure according to the preferred embodiment of the present invention.

FIG. 7 is another perspective view showing the application of the manual brake structure according to the preferred embodiment of the present invention.

FIG. 8 is also another perspective view showing the application of the manual brake structure according to the preferred embodiment of the present invention.

FIG. 9 is a perspective view showing the exploded components of a conventional manual brake structure.

FIG. 10 is a cross sectional view showing the operation of the conventional manual brake structure.

### DETAILED DESCRIPTION OF THE PREFERRED EMBODIMENTS

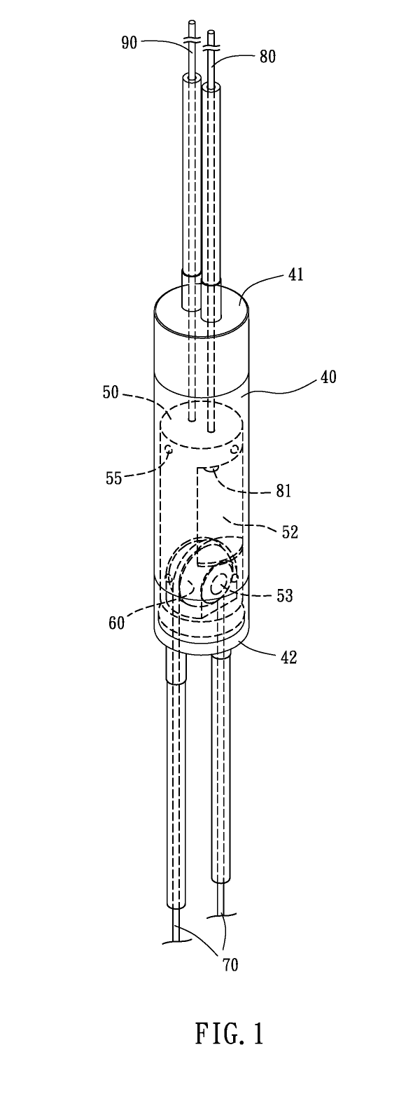

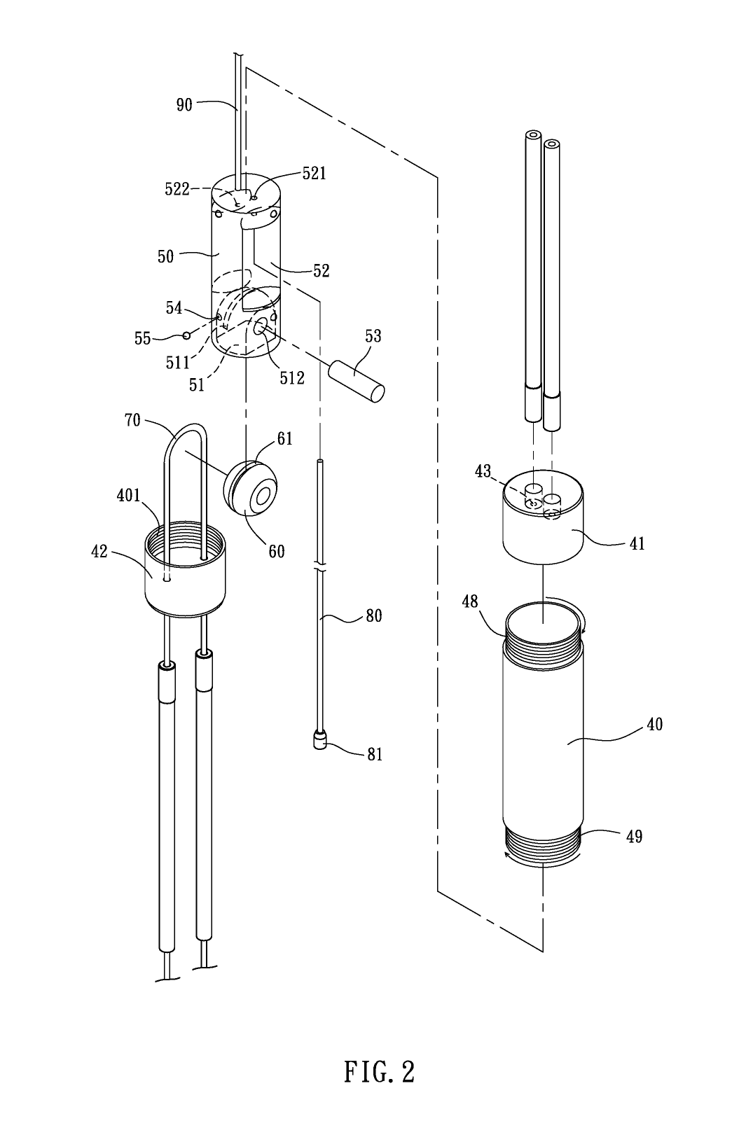

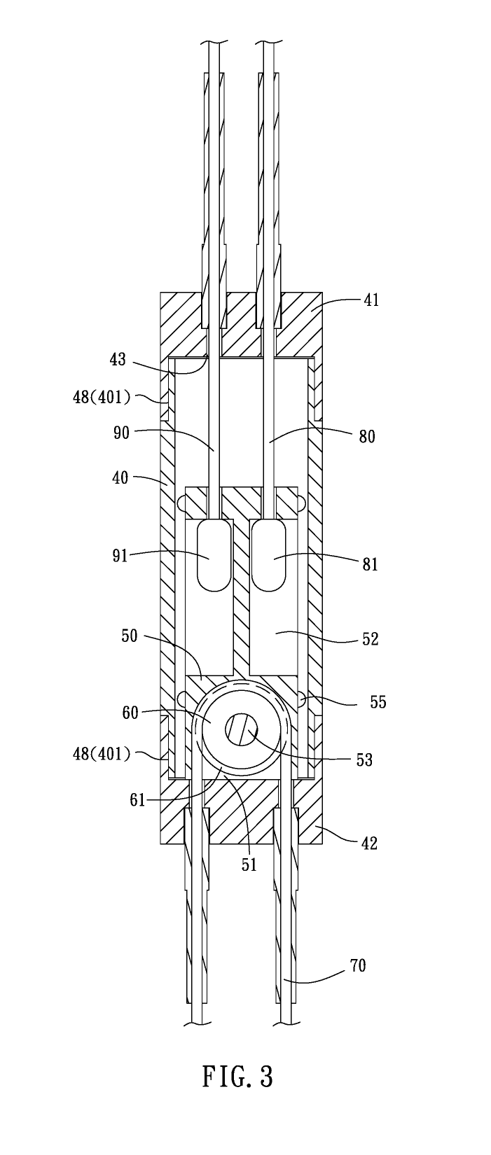

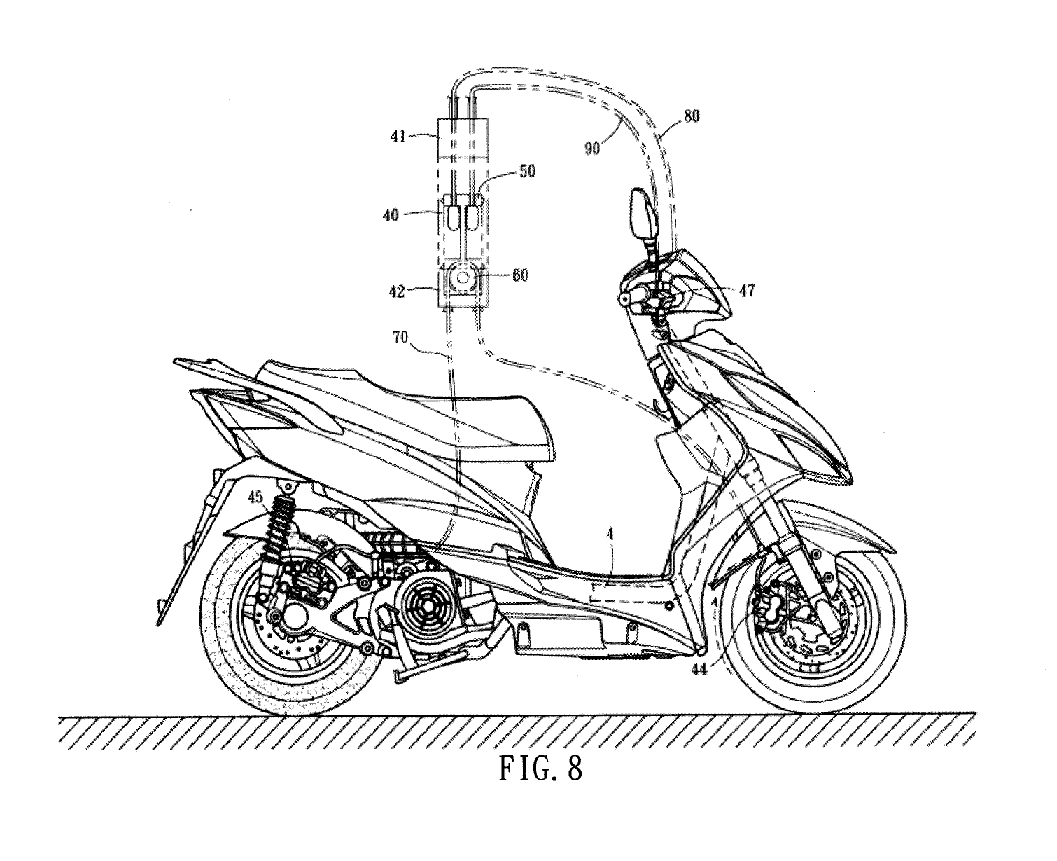

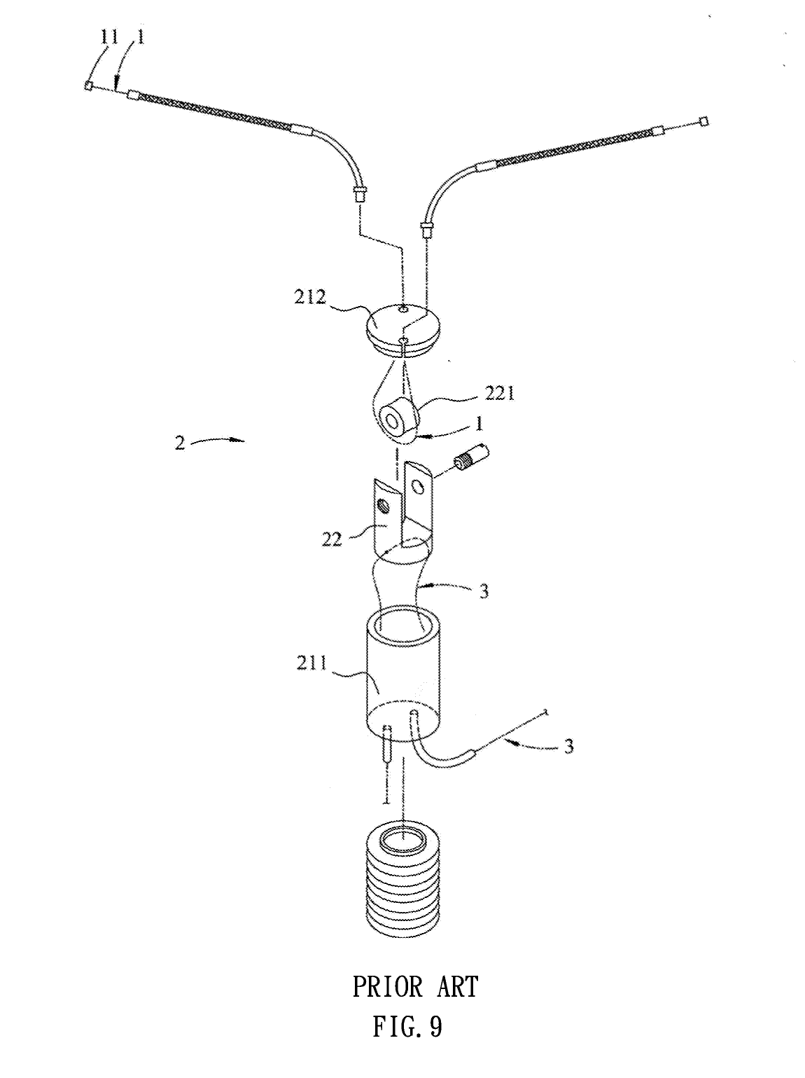

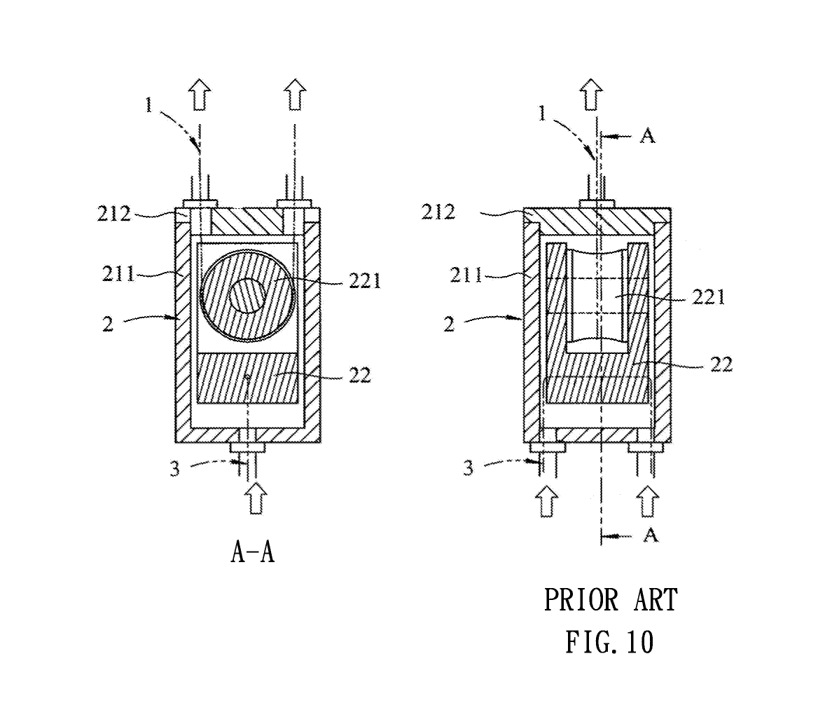

With reference to FIGS. 1 to 8, a manual brake structure according to a preferred embodiment of the present invention is employed to stop a bicycle or motorcycle 4, and the manual brake structure comprises a casing 40, a body 50, a roller 60, a first brake line 70, a second brake line 80, and a third brake line 90.

The casing 40 is a hollow cylinder and includes a first threaded portion 48 formed on a first end thereof and configured to screw with a first cap 41, and the casing 40 also includes a second threaded portion 49 arranged on a second end thereof and configured to screw with a second cap 42, wherein the first cap 41 has two through orifices 43 configured to accommodate the second brake line 80 and the second brake line 90 respectively, and the second cap 42 has two through orifices 43 configured to accommodate the first brake line 70, wherein the first cap 41 also has a screwing portion 401 defined on an inner wall thereof and corresponding to the first threaded portion 48, and the second cap 42 also has a screwing portion 401 defined on an inner wall thereof and corresponding to the second threaded portion 49.

The body 50 is housed in the casing 40 and includes a first accommodation portion 51 formed in a first end thereof, and the body 50 also includes a second accommodation portion 52 formed in a second end thereof, wherein the first accommodation portion 51 has a slot 511 and a first aperture 512 defined below the slot 511, such that after the roller 60 is housed in the first accommodation portion 51, it is rotatably connected with the first aperture 512 by using a coupling shaft 53. The second accommodation portion 52 passes through the second end of the body 50 or has two independent spaces formed on two opposite sides of the second end of the body 50, wherein the second accommodation portion 52 also has two second apertures 521, 522 defined on each of the two independent spaces of the second accommodation portion 52. The body 50 further includes multiple holes 54 defined on an outer surface of the first end thereof so as to accommodate multiple steel balls 55 respectively, such that the body 50 rotates in the casing 40 by way of the steel balls 54.

The roller 60 includes a hollow opening passing through a central position of two opposite sides thereof so as to accommodate the coupling shaft 53, such that the roller 60 is rotatably fixed in the first accommodation portion 51 by way of the coupling shaft 53. The roller 60 further includes a trench 61 defined around a peripheral wall thereof.

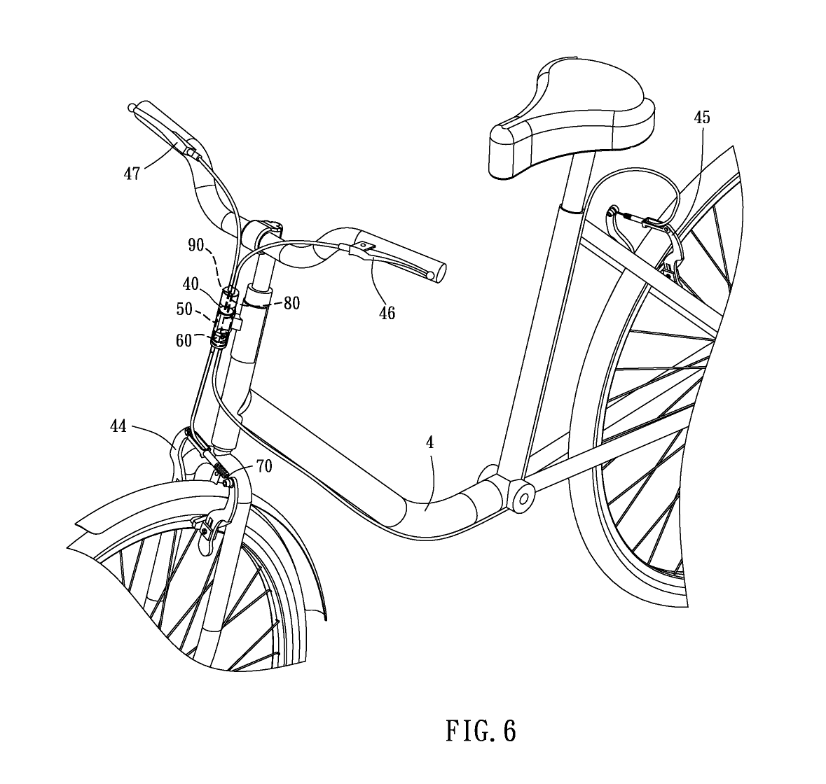

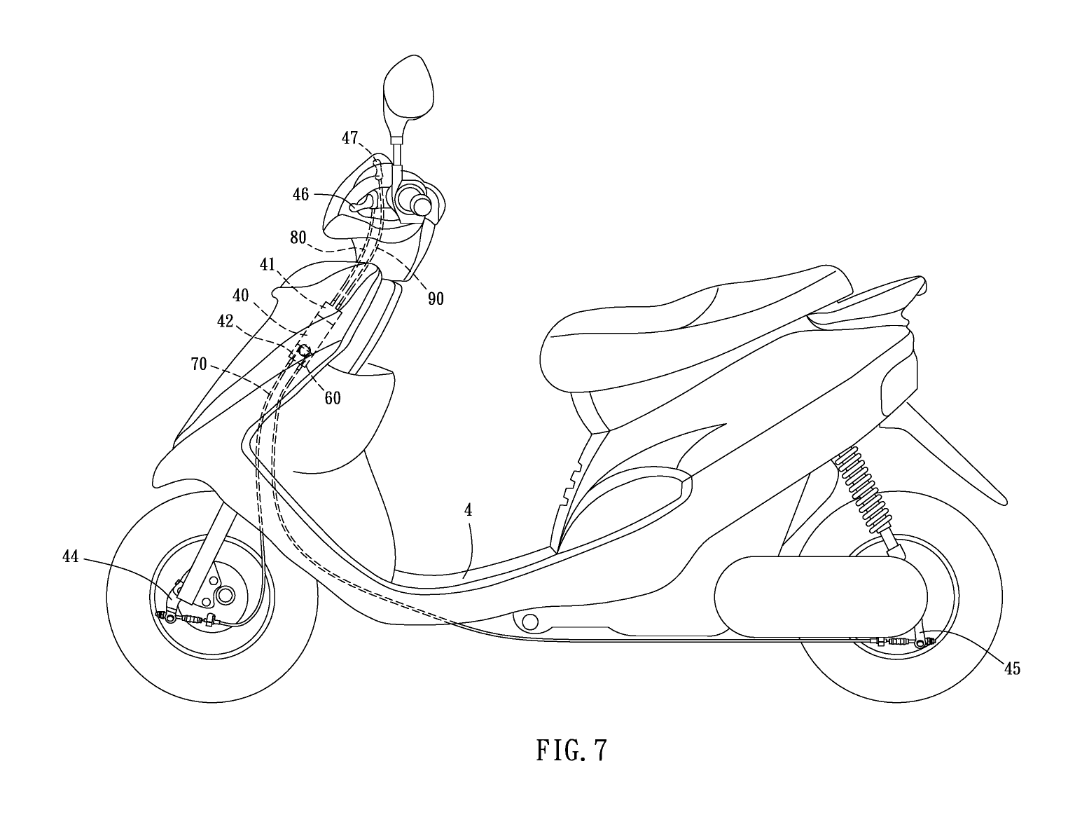

An intermediate section of the first brake line 70 is bent in half and is fitted into the trench 61 of the roller 60, and two ends of the first brake line 70 are respectively connected with a first brake 44 and a second brake 45 of the bicycle or motorcycle 4, wherein each of the first brake 44 and the second brake 45 is a drum brake or a disc brake, as shown in FIGS. 6 to 8. The first brake line 70 is fitted into the trench 61 and is rotatably accommodated in the first accommodation portion 51 with the roller 60, such that the first brake line 70 is housed in slot 511.

The second brake line 80 includes a first stop block 81 secured on a first end thereof, and a second end of the second brake line 80 extends out of the second aperture 521 of the second accommodation portion 52 and couples with a first controller 46 of a first handle of the bicycle or motorcycle 4.

The third brake line 90 includes a second stop block 91 mounted on a first end thereof, and a second end of the third brake line 90 extends out of the second aperture 522 of the second accommodation portion 52 and couples with a second controller 47 of a second handle of the bicycle or motorcycle 4.

In assembly, the first brake line 70, the second brake line 80, and the third brake line 90 are inserted through the two through orifices 43 of the second cap 42 and the two through orifices 43 of the first cap 41, the first cap 41 is screwed with the first threaded portion 48 of the casing 40, and the second cap 42 is screwed with the second threaded portion 49 of the casing 40.

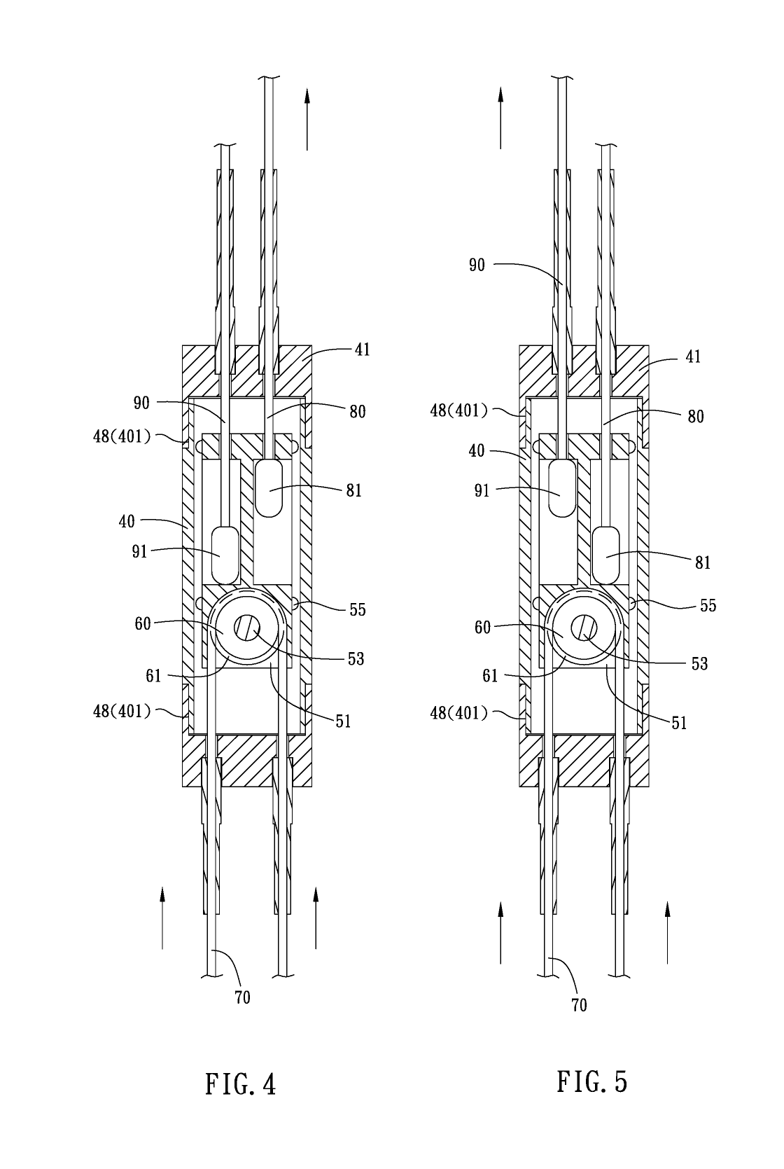

In operation, the intermediate section of the first brake line 70 is rotatably connected with the roller 60 and the two ends of the first brake line 70 are connected with the first brake 44 and the second brake 45, the second brake line 80 couples with the first controller 46, and the third brake line 90 couples with the second controller 47, such that when the second brake line 80 or the third brake line 90 is pulled as stopping the bicycle or motorcycle 4 (as illustrated in FIGS. 4 and 5), the first brake line 70 pulls the first brake 44 and the second brake 46 by using the roller 60, thus braking two wheels of the bicycle or motorcycle 4 simultaneously.

Preferably, the roller 60 drives the first brake 44 and the second brake 46 to stop the two wheels of the bicycle or motorcycle 4 gently.

In addition, when the first brake line 70 is loose, its tightness is adjusted automatically by the roller 60 so as to stop the two wheels quickly and stably.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A manual brake structure being employed to stop a bicycle or motorcycle and comprising:
a casing being a hollow cylinder and including a first cap arranged on a first end of the casing, the casing also including a second cap arranged on a second end of the casing, and each of the first cap and the second cap having two through orifices;
a body housed in the casing and including a first accommodation portion formed in a first end of the body so as to house a roller, and the body also including a second accommodation portion formed in a second end of the body, the second accommodation portion having two first apertures defined on the second accommodation portion;
the roller including a trench defined around a peripheral wall of the roller;
a first brake line, an intermediate section of which is bent in half and is fitted into the trench of the roller, and two ends of the first brake line being respectively connected with a first brake and a second brake of the bicycle or motorcycle;
a second brake line including a first stop block secured on a first end of the second brake line, and a second end of the second brake line extending out of the first aperture of the second accommodation portion and coupling with a first controller of the bicycle or motorcycle;
a third brake line including a second stop block mounted on a first end of the third brake line, and a second end of the third brake line extending out of the first aperture of the second accommodation portion and coupling with a second controller of the bicycle or motorcycle.

2. The manual brake structure as claimed in claim 1, wherein the second accommodation portion passes through the second end of the body or has two independent spaces formed on two opposite sides of the second end of the body.

3. The manual brake structure as claimed in claim 1, wherein the first accommodation portion has a slot 511 and a second aperture defined therein, such that after the roller is housed in the first accommodation portion, it is rotatably connected with the second aperture by using a coupling shaft.

4. The manual brake structure as claimed in claim 1, wherein the first accommodation portion has a slot defined above the second aperture and configured to house the first brake line.

5. The manual brake structure as claimed in claim 1, wherein the casing includes a first threaded portion formed on a first end thereof and configured to screw with a first cap, and the casing also includes a second threaded portion arranged on a second end thereof and configured to screw with a second cap, wherein the first cap also has a screwing portion defined on an inner wall thereof and corresponding to the first threaded portion, and the second cap also has a screwing portion defined on an inner wall thereof and corresponding to the second threaded portion.
